(19) United States
(12) Patent Application Publication
(10) Pub. No.: US 2002/0009400 A1
(43) Pub. Date: Jan. 24, 2002

(54) REACTOR

(76) Inventors: DAVID STEWART CONOCHIE, CAMBERWELL (AU); DARREN JAMES MATTHEWS, GREENSBOROUGH (AU)

Correspondence Address: HARNESS DICKEY & PIERCE, PO BOX 828, BLOOMFIELD HILLS, MI, 48303

(21) Appl. No.: 09/341,406

(22) PCT Filed: Jan. 7, 1998
(86) PCT No.: PCT/AU98/00005

(30) Foreign Application Priority Data
Jan. 8, 1997 (AU) P0 4513

(51) Int. Cl. F28D 9/00; F28F 3/12; B01J 19/00

(52) U.S. Cl. 422/198; 422/205; 422/206; 422/242

(57) ABSTRACT

A reactor (20) and a process for upgrading solid materials, such as coal, having low thermal conductivity are disclosed. The reactor includes an outer shell (10) that defines an internal volume for retaining a packed bed of solid materials to be treated and a plurality of plates (12a to 12h) of a thermally conductive material positioned within the internal volume. Each plate includes one or more passageways (14a to 14h) through which a heat transfer fluid can flow. In use, each plate defines one or more thermally conductive bypass or bypasses between the heat transfer fluid and the solid materials in the region of the plate so that in use substantially all of the solids are heated or cooled to a desired temperature range by heat exchange between the heat transfer fluid and the solids via the plates.

The present invention relates to a reactor for use in a process, especially a high pressure process, in which it is necessary to transfer heat to or from a low thermal conductivity charge of material containing solids, such as coal. The present invention also relates to the process.

A number of industrial processes require that a charge of material containing solids be heated or cooled in order to initiate and sustain a chemical reaction or physical changes. Typically, it is necessary to heat the charge to an elevated temperature for the chemical reaction or physical change to occur. Unfortunately, many charges of solid materials have very low thermal conductivities and it is difficult to heat such charges of material using indirect heat exchange. Such charges are frequently heated by direct heat exchange, for example, by passing hot gases through the charge of solids.

As used throughout this specification, “direct heat exchange” refers to heat exchange processes in which a heat transfer fluid comes into direct contact with the material to be heated or cooled, and “indirect heat exchange” refers to heat exchange processes in which the heat exchange fluid is separated from the material being heated or cooled by a physical barrier, such as the wall of a tube.

Some processes are not amenable or suitable for direct heat transfer. The ratio of heat capacitance between solids and gases is such that large volumes of gas or fluid are required to transfer the heat. For example, flow of the large volumes of gas required for heat transfer through a packed bed is not possible unless the bed is very coarse or heating and cooling times are very long. In the case of processes involving coal and other materials which contain substances which may be volatile at elevated temperatures, direct heat transfer may result in volatile material being driven off with the heating gas which could cause difficulties in cleaning the offgas prior to emission of the offgas through the flue or stack. In other processes, direct heat exchange may lead to solids handling difficulties or maintenance problems caused by solids carry over in gas streams. In such processes, it is necessary to utilise indirect heat exchange to heat the solids charge.

One known indirect heat exchange process is the upgrading of coal, particularly low rank coal, by the simultaneous application of temperature and pressure described in U.S. Pat. No. 5,290,523 to Koppelman. In this process, heating a charge of coal under elevated pressure results in water being removed from the coal by a squeeze reaction caused by structural realignment of the coal and also by decarboxylation reactions. Furthermore, some soluble ash-forming components are also removed from the coal. This results in upgrading of coal by thermal dewatering and upgrading of the calorific value of the coal. By maintaining the pressure sufficiently high during the upgrading process, vaporisation of the removed water can be substantially avoided which reduces the energy requirement of the process. Furthermore, the by-product water is produced mainly as a liquid rather than as steam or vapour.

The thermal processing of coal requires heat transfer to the coal, (typically 300-600 Btu/lb) but the effective thermal conductivity of a packed bed of coal is approximately 0.1 W/mK, making the coal bed a good thermal insulator.

Options that might be considered to accelerate heating of coal to provide a process which achieves a reasonable heat-up time of a coal bed include:

Increase of thermal driving force by increasing the temperature of the heat transfer medium. This tends to lead to devolatilisation of coal which for low rank coal upgrading reduces the heating value of the product. Moreover, this also leads to condensation of tars and other volatilised materials in other parts of the reactor system.

Use of fluid beds. This leads to the need to circulate large volumes of (inert) gas which again accentuates the problem of devolatilisation of the coal. It also requires gas cooling and cleaning before recompression or the operation of a hot dirty compressor, both of which involve capital and maintenance.

Use of agitated beds such as a rotary kiln. The operation of such reactors at elevated pressures, with inert atmosphere, involves massive engineering difficulty and expense. Indirect heat exchange is preferred, but this further complicates the engineering difficulties and the volume occupancy of coal in the reactor can be low.

Use of flash drying of a ground feed. This requires subsequent agglomeration to produce a marketable product. It also requires an inert gas for heat exchange and the reactive volumes tend to be large because of the dispersed state of the solids.

Hydrothermal dewatering of coal in which the coal is ground to a small particle size and mixed with water to form a slurry and the slurry is subsequently heated to an elevated temperature at elevated pressure to maintain liquid conditions. This process requires grinding of coal which must then be either agglomerated or used directly in a process, such as at a power station. Furthermore, the mass of water heated to elevated temperature is large and this requires large heat exchangers for heat recovery.

With the simultaneous application of high pressure (greater than 10 barg), each of the above options become more difficult.

A packed bed combined with indirect heat transfer is preferred for processing coal by heating or cooling of the bed of material because of the minimisation of volatile loss, the lower energy consumption, and the production of the majority of the by-product water as liquid.

A packed bed also allows a wider range of coal sizes, and coarser coal sizes than would be preferred for a fluid bed operation. A packed bed also gives the smallest volume to contain in a high pressure reactor, provided the heating rates are high. A small reactor volume leads to savings in pressurisation time and reactor cost.

The classical approach for enhancing indirect heat exchange is to provide sufficient surface area between the heating medium and the charge to be heated. This leads to bundles of tubes, with heating medium either on the inside or the outside of the tubes. Such tube bundles may be appropriate to transfer heat to liquids and gases (although they are prone to scaling and buildup, requiring maintenance) but they have some limitations when used in the heating of solids. This is particularly so in the case where the solids comprise coal that may have a particle size of up to 19 mm (0.75 inch), or even export size coal having particle sizes of up to 50 mm (2 inches), where problems of bridging and sticking are encountered. Any heat exchange system for such materials must be designed to allow free flow of solids, either at the start-and end of a cycle in a batch process, or during a continuous process.

A further difficulty with the above-described prior art shell and tube arrangements arises from the fact that most prior art reactors require a discharge cone to be positioned at the lower end of the tube bundle in the reactor in order to discharge the coal from the reactor. It is almost impossible to have the tube bundle extend into the discharge cone and accordingly the appreciable volume of coal that is contained in the discharge cone is not heated by the tube bundle. To overcome this difficulty, some processes incorporate water injection or steam injection into the coal bed. These are known as working fluids. Such working fluids may be vaporised (if liquid) and superheated in the upper sections of the bed and then flow to the outlet at the at the bottom of the discharge cone. Cold solids in the discharge cone are thereby heated by the working fluid (by convection and possibly by condensation of the working fluid). However, injection of a working fluid has serious consequences for the energy utilisation of the process.

One prior art process utilises a shell and tube type heat exchange apparatus in which coal is fed to the tube side and a heat transfer oil flows through the shell side. The tubes have a diameter of typically 75 mm (3 inches) which means that the maximum distance for heat transfer is about 38 mm (1 1 inches) ie. the distance from the wall of the tube to the centre of the tube. Although small diameter tubes have advantages when operating at high pressures, such reactors are not ideal because it can be difficult to get solids to flow through the tubes. Moreover, short circuiting and channelling of the heat transfer oil on the shell side may occur (which leads to incomplete processing of the coal) and the reactor design is complex and difficult to engineer. In particular, the end plates for the tube bundle are difficult to engineer and are very thick and expensive components. The volume occupancy of coal in such reactors is typically only 30-50% of the total volume of the reactor.

The present inventors have now designed a reactor that is suitable for use in upgrading coal, and also suitable for use in any process in which it is necessary to transfer heat to or from a charge of solid material having low thermal conductivity. The reactor uses the process concept of a conductive bypass.

According to the present invention there is provided a reactor for use in a process in which a charge of material containing solids is supplied to the reactor and forms a packed bed of solids in the reactor and is subjected to heat transfer to heat or cool the charge, the charge having a low thermal conductivity, which reactor includes an outer shell that defines an internal volume for the packed bed and a plurality of plates of a thermally conductive material positioned within the internal volume, and each plate includes one or more passageways through which a heat transfer fluid can flow, and each plate in use defines one or more thermally conductive bypass between the heat transfer fluid and the solids in the region of the plate such that in use substantially all of the solids are heated or cooled to a desired temperature range by heat exchange between the heat transfer fluid and the solids via the plates.

The reactor of the present invention was developed following studies by the present inventors on upgrading coal. These studies found that there was minimal heat transfer resistance on the heat transfer fluid side of the reactor and that the limitation on heat transfer was mainly on the coal side. Then, surprisingly, it was found that by inserting an additional resistance to heat transfer between the heat transfer fluid side and the coal side, it was possible to operate the process with an improved reactor design. The basis of the invention is to use a conductive bypass (ie. a thermal conductive bypass) between the heat transfer fluid side and the coal side which minimises the length of the heat transfer path through coal. As described above, in accordance with the present invention each plate defines one or more conductive bypass between the heat transfer fluid and the solids in the region of the plate.

The maximum heat transfer distance is an important parameter in the unsteady state heat transfer of solids, and in particular in a packed bed of solids. Time to heat and time to cool is critically dependent on the maximum heat transfer distance, as is well known to those skilled in the art. The design of heated or cooled plates allows one configuration of coal bed with the maximum heat transfer distance being kept to a carefully optimised value throughout the coal bed. At the same time, the use of a conductive bypass allows the supply side heat transfer area in contact with the heat transfer fluid to be kept to a minimum. Advantages derived from minimum heat transfer fluid volume include optimised flow, improved volume occupancy of the reactor by the packed bed, and optimum heat transfer on the supply side. Minimum heat transfer fluid volume also has advantages when designing for possible rupture in the between the heat transfer fluid and the pressurised vessel volume.

In use of the reactor of the present invention, heat exchange occurs between the heat transfer fluid flowing through the passageways in the plates and the plates by thermal conduction. This heat transfer alters the temperature of-the plates. Heat transfer then occurs between the outer surfaces of the plates and the charge of the material.

The conductive bypass, as used in the present invention allows both the supply side and the coal bed side heat transfer distances to be optimised, and the maximum heat transfer distance in the bed also to be minimised without increasing the amount of heat transfer fluid or the supply side heat transfer surface in the coal bed.

Throughout this specification, the term “plate” is used to encompass any three-dimensional shape that has an extent in one dimension that is substantially shorter than the extent of the other two dimensions. For example, a plate may include a planar plate or an annular or cylindrical plate.

Throughout this specification, the term “packed bed” is understood to mean that the particles in the bed are in contact with each other.

It is noted that the term “packed bed” does not exclude movement of the particles through a reactor which contains the packed bed—provided the particles remain in contact.

It is also noted that the term “packed bed” does not exclude localised movement of particles within a generally static bed.

In the case of coal, typically the term “packed bed” means that the bulk density of the bed is 600-800 kg/m³.

Preferably, the reactor includes an inlet means for introducing the charge into the reactor and an outlet means for removing the charge from the reactor.

Preferably, the plates are positioned relative to each other such that in use the solids can flow between adjacent plates during loading and unloading of the reactor.

Preferably, the adjacent plates are spaced from 50-500 mm (2-20 inches) apart, more preferably from 75 to 200 mm (3-8 inches) apart, and more preferably from 75 to 125 mm (3-5 inches) apart.

The reactor of the present invention is especially suitable for use in processes that are operated at high pressure, for example at pressures of 2 barg (29.4 psi) or more and preferably at pressures of 4 barg or more.

The reactor is advantageously used in high pressure processes that require the outer shell to be rated as a pressure vessel.

The plates are made from one or more thermally conductive materials.

It is preferred that the thermal conductivity of the plates be at least an order of magnitude higher than the thermal conductivity of the charge of material in the reactor during operation.

In many processes in which the solids are processed at elevated pressures, the solids must be maintained under a pressure that is much higher than the pressure required to pump the heat transfer fluid through the passageways. For example, in the dewatering of coal, the heat transfer fluid (which is normally a heat transfer oil) is circulated at approximately 150 psi (1033 kPa) whereas the coal is held under a pressure of 800 psi (5510 kPa). Therefore, it is preferred that the plates in the reactor of the present invention comprise one or a small number of passageways through which the heat transfer fluid can flow. More preferably, the passageways have a relatively small diameter or width and the thickness of the walls of the passageways is quite large. Expressed in slightly different terms, it is preferred that the volume of the passageways be a small percentage of the total volume of the plates. This assists in ensuring that the walls of the passageways are sufficiently strong to resist the pressure differential caused by the difference in pressure between the pressure applied to the outside of the plates and the inside of the passageways. Compared to heat jackets, the plates used in the reactor of the present invention are strong and able to resist collapse or crushing at elevated pressure.

Apart from the passageways, it is preferred that the plates be solid.

The plates may be made from any suitable high thermal conductivity material.

It is preferred that the material of construction for the plates be substantially chemically inert to the heat transfer fluid flowing through the passageways, the solid material being processed in the reactor, which solid material is in contact with the outside of the plates, and any gases or liquids in the reactor. It will also be appreciated that such plates and any supporting means and piping means associated with the plates will need to have resistance to erosion and abrasion from coal entry, flow and discharge.

Heat conductive metals or composites are suitable materials for use in the plates. Suitable metals include copper, aluminium, stainless steel and mild steel. Composite materials such as stainless steel coated copper, chromium coated copper, plasma sprayed mild steel, or copper cast into a thin mild steel coating may also be used. It will be appreciated that this list of materials is not exhaustive and that a number of high thermal conductivity metals may be used in the plates without departing from the scope of the invention.

The shape of the plates may vary widely, although plates that have a rectangular, parallelogram or tapering cross section are preferred.

It is also preferred that the outer surfaces of the plates include substantially planar surfaces, although other shapes may also be used. The plates may also be cylindrical plates or annular plates positioned concentrically within the reactor.

The passageways in the plates may be manufactured by machining the passageways into the plates (eg. by drilling), or by casting the plates with the passageways therein, or by any other fabrication method. A preferred method for constructing the passageways includes casting or rolling or machine edging a channel into the edge of a plate and the subsequently welding or otherwise joining another plate to that edge to form the completed plate.

The optimum design for the plates depends upon the maximum heat flux required in the reactor, the average heat flux of the process conducted in the reactor and the duration of the cycle or residence time. It also depends on the material of construction of the plates.

The plates may be arranged side by side, stacked in layers or stacked end to end. Optimum spacing of the plates will generally be determined by processing requirements on the solids side of the reactor. The passageways for flow of heat transfer fluid through the plates may be single or multiple in a unit, with flow in either direction, or with return flow in the same plate or an adjacent plate.

If stacked series of plates are used, the plates may be connected to the source of heat transfer fluid in series or in parallel or indeed the layers may be connected to separate sources of heat transfer fluid. Using stacked layers of plates allows for the possibility of separate temperature control in the layers, which may be advantageous if zonal heating of the reactor is desired.

It is also possible to switch heat transfer fluids flowing through the plates. For example, if the process being conducted in the reactor requires heating of the charge, followed by cooling of the charge, a hot heat transfer fluid may be passed through the plates to heat the charge. The heat transfer fluid may then be switched such that a cool heat transfer fluid then passes through the plates to cool the plates and the charge. Due to the minimum volume of the passageways in the plates, the first heat transfer fluid can be rapidly purged from the passageways, enabling relatively rapid switching of heat transfer fluids and the thermal bypass (plates) will cool rapidly due to good contact between the heat transfer fluid and the material of high thermal conductivity.

The spacing between adjacent plates effectively defines a flow passage for solids. Therefore, the spacing between adjacent plates should be sufficiently large to ensure that undue blocking or bridging between plates by the solids does not occur. Moreover, the spacing between the plates must be sufficiently small to ensure that adequate rates of heat transfer to all of the solids between the plates is achieved. For solid materials such as coal, which have a very low thermal conductivity, a practical maximum for spacing between adjacent plates is 200 mm (8 inches), with 100 mm (4 inches) spacing being more preferred as shorter batch times or residence times can be used.

In a preferred embodiment, the reactor includes a substantially cylindrical portion with the plates arranged such that when viewed in cross-section the plates substantially extend across chords of the circular cross-section of the cylindrical portion. It is preferred that the plates extend substantially along the length of the cylindrical portion of the reactor.

It is also common practice to orient such reactors such that the longitudinal axis of the cylindrical portion is substantially vertical.

Such reactors are also commonly provided with a discharge cone that may comprise up to 20% of the volume of the reactor.

It is also preferred that the reactor further includes one or more plates positioned within the discharge cone portion of the reactor, said plates including one or more passageways for flow of a heat transfer fluid therethrough. The plates in the discharge cone are preferably shaped to avoid blockages in the solid flow. The plates may be shaped or truncated to facilitate the solids flow whilst still providing adequate heating or cooling of the solid material in the cone. Many geometries are possible, including radial plates, flow line plates, fingers, side wall plates and bent plates.

The plates may be connected to one end of the reactor. In use, the heat transfer fluid is supplied from a source of heat transfer fluid by one or more heat transfer fluid lines extending through the outer shell of the reactor to the passageways in the plates. Preferably, the plates are suspended from an upper part of the reactor. This arrangement is preferred because the potential impediment to solids flow is minimised. It may also be possible to connect the plates to a lower part of the reactor and this is suitable if it is desired to have the heat transfer fluid drain from the plates when a heat transfer fluid circulating pump is turned off. Use of this arrangement may be preferred if molten salts are used as the heat transfer fluid as it is advantageous to ensure that such salts are drained from the passageway in order to avoid potential freezing of the molten salts in the passageways.

In one embodiment, the plates are preferably fairly loosely connected to the reactor. For example, the plates may be suspended by chains or they may be hingedly connected to the wall of the reactor. This arrangement allows the plates to move or be moved or vibrated if a solids blockage between the plates occurs.

The plates may include additional channels whereby working fluids or reagents maybe added to or removed from the bed.

The outer shell of the reactor may be lined with an insulating material, such as a refractory lining, and possibly a wear liner. Use of an insulating liner allows reduction in shell design thickness and advantages of cold operating flanges and improved safety and heat balance.

The reactor may further include inlet means for supplying gases or liquids to the reactor. The gases or liquids may comprise pressurising fluids or working fluids. The reactor may also include outlet means for gases or liquids.

In the reactor of the present invention it is possible to separately optimise the heat transfer of the heat transfer fluid side and also of the solids side. Only a relatively small surface area for heat transfer is required on the heat transfer fluid side and this is provided by the passageways in the plates. In contrast, a large heat transfer surface area is required on the solids side due to the low thermal conductivity of solids such as coal, and this large surface area for heat transfer is provided by the exterior surface of the plates. Separately optimising the heat transfer enables the volume of heat transfer fluid required in inventory to be minimised which reduces capital cost. Reduction in inventory may also enable higher operating temperature fluids, or less flammable material to be economically used. Furthermore, the heat transfer fluids presently available have a finite life and minimising the volume required has an apparent effect on the economies involved in replacing the heat transfer fluid.

In another aspect, the passageways in the plates may be replaced by heating means for heating the plates. Such heating means may comprise, for example, electrical resistive heaters. In this aspect, instead of using a heat transfer fluid to heat the plates, the heating means heats the plates (and subsequently heats the charge).

In another aspect, the heat transfer passageways in the plates are retained and heating means included to heat the heat transfer fluid in the passageways. The reactor of the present invention is suitable for use in high pressure processes used for treating a charge of solid material having low thermal conductivity. The reactor is especially suitable for use in the upgrading of coal.

According to the present invention there is also provided a process for heating or cooling solids having low thermal conductivity in a reactor having an outer shell and a plurality of plates of thermally conductive material positioned within the outer shell, each of said plates having one or more passageways for flow of a heat transfer fluid therethrough, and each plate defining in use one or more thermally conductive bypass between the heat transfer fluid and solids in the region of the plate, which method includes the steps of charging the solids into the reactor to form a packed bed in the outer shell, passing a heat transfer fluid through said passageways and heating or cooling solids in the packed bed by heat transfer between the heat transfer fluid and solids via the plates, and removing solids from the reactor.

Preferably the method includes the step of pressurising the packed bed of solids.

When the process is operated to heat solids, preferably the process also includes maintaining the packed bed under conditions of elevated temperature and elevated pressure for a time sufficient to upgrade the solids.

Preferably the solids are coarse.

Throughout this specification, the term coarse is understood to mean a particle size greater than 5 mm.

Preferably, the process of the present invention is conducted as a batch process.

Preferred embodiments of the present invention will now be described by reference to the accompanying drawings in which:

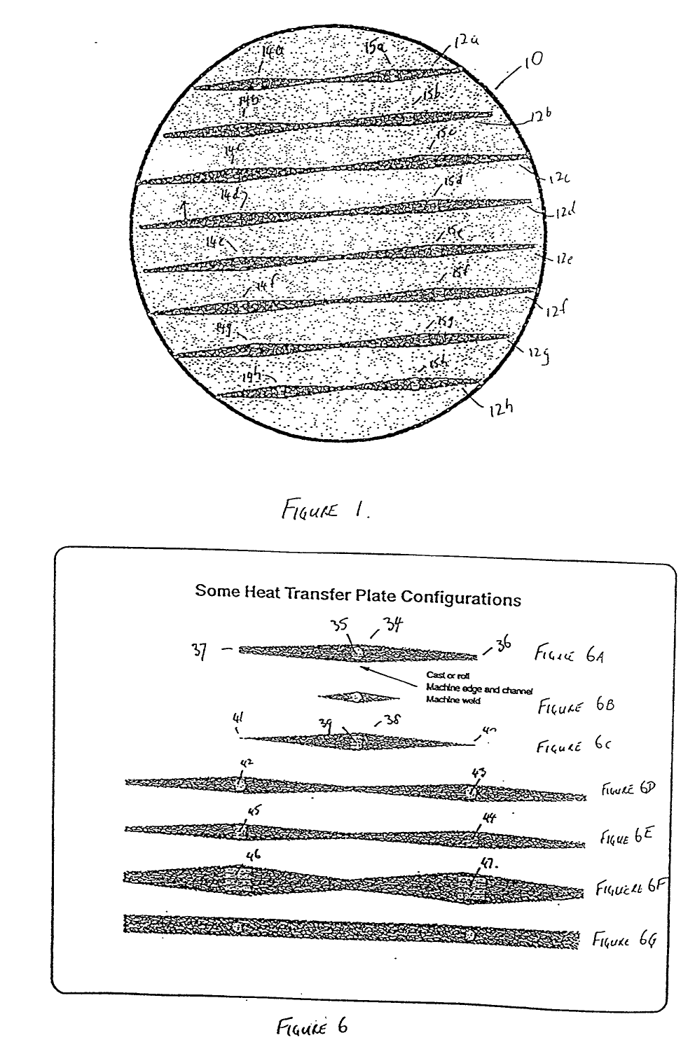

FIG. 1 shows a cross-sectional view through an embodiment of a reactor in accordance with the present invention;

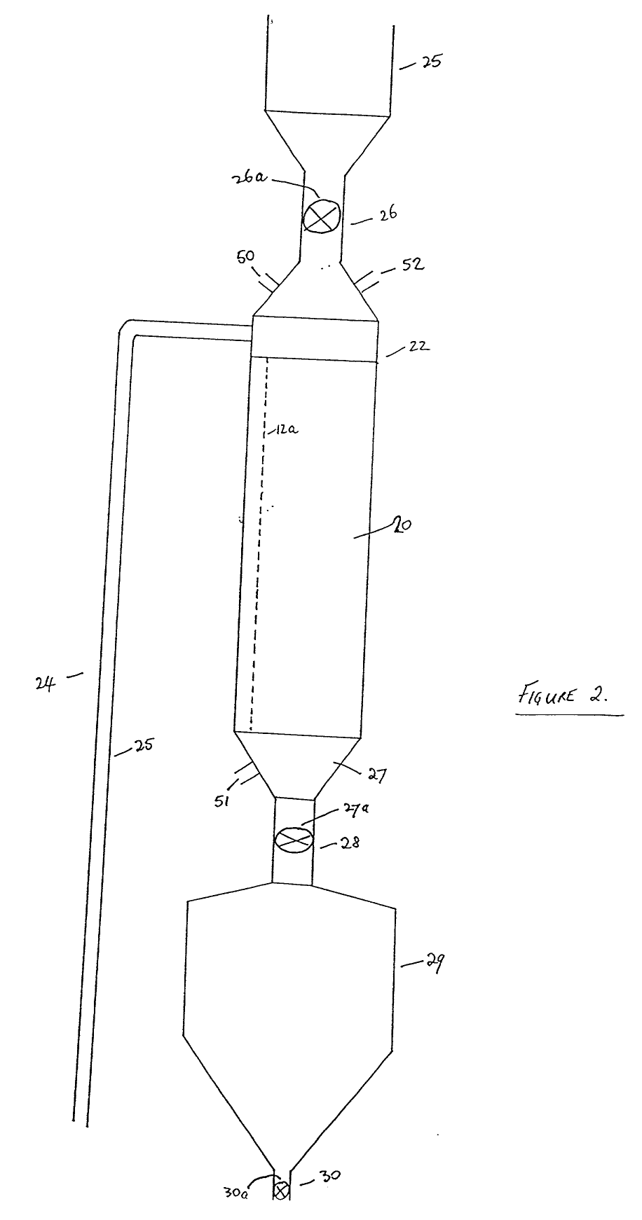

FIG. 2 shows a side elevation of an apparatus, including the embodiment of the reactor of the present invention shown in FIG. 1, for dewatering coal;

FIG. 3 shows a side view of the discharge cone on the reactor shown in FIGS. 1 and 2, with one embodiment of an arrangement of plates to ensure processing of coal in the discharge cone;

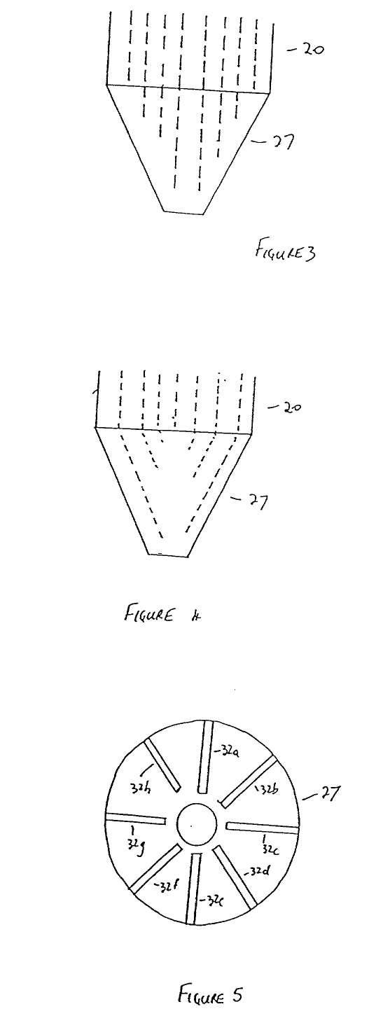

FIG. 4 shows a similar view to FIG. 3, but with another arrangement of plates;

FIG. 5 shows a cross-sectional plan view of the discharge cone showing one arrangement of radial plates in the discharge cone to ensure an arrangement of radial plates in the discharge cone to ensure processing of the coal in the discharge cone;

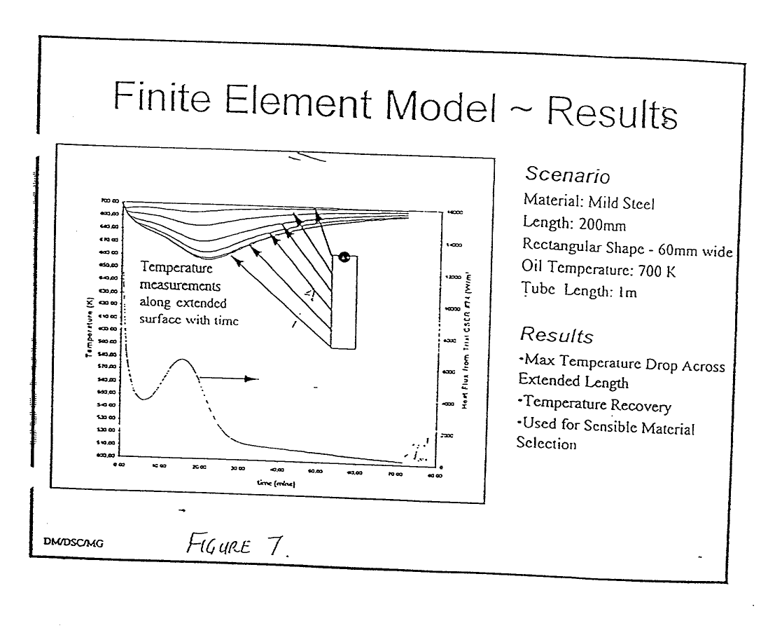

FIG. 6 shows alternative plate configurations; and

FIG. 7 shows a time-temperature profile for points in a rectangular plate subjected to heat flux associated with coal upgrading by the Koppelman process.

In FIG. 1, the reactor includes an outer shell 10 having a plurality of plates 12a to 12h. Although FIG. 1 shows eight plates in the reactor, it will be appreciated that a lesser or greater number of plates may be used. Each plate 12a to 12h includes two channels 14(a-h), 15(a-h), through which a heat transfer oil can flow.

Referring now to FIG. 2, which shows a side elevation of an apparatus for dewatering coal, the apparatus includes reactor 20. The reactor 20 has a cross section essentially the same as that shown in FIG. 1. The reactor 20 has a suspension and oil feed plate 22 positioned at a top portion thereof. The plates 12a-12h are suspended from chains attached to a series of hooks positioned around the inner periphery of the plate 22. It is noted that any suitable suspension means and supporting means may be used to suspend or support the plates in the reactor. Plate 12a is shown in dotted outline in FIG. 1 and, as can be seen, plate 12a extends along the substantial length of reactor 20. Oil supply line 24 connected to hot oil supply (not shown) supplies oil to the plates 12a-12h via manifold arrangements (not shown). Oil return line 25 returns the oil to the oil supply means.

In one particular embodiment, reactor 20 is approximately 7 meters (23 feet) long and has a diameter of around 1 meter (3.3 feet).

Reactor 20 is also fitted with gas/liquid inlet 50 for introducing pressurising fluid and/or working fluid into the reactor. The reactor also has a fluid outlet 51 for removing working fluid and other fluids from the reactor and a further fluid outlet 52 for releasing pressure from the reactor.

In order to facilitate loading of the reactor 20 with coal, the reactor 20 includes a feed hopper 25 positioned above and offset from the top of reactor 20. Feed hopper 25 may be offset from reactor 20 to allow removal of the plates 12a-12h either singly or as an assembly, for maintenance or replacement. Feed hopper 25 is connected to reactor 20 via offset conduit 26 and coal flows from feed hopper 25 through offset conduit and into reactor 20. Offset conduit 26 includes valve 26a to control the charging of coal. In use, the coal flows downwardly through the flow passages defined by the facing surfaces of adjacent plates 12a, 12b etc. and fills the reactor as a packed bed.

The bottom of the reactor 20 is fitted with a discharge cone 27 to enable discharge of coal therefrom. When the reactor 20 is filled with coal, discharge cone 27 also fills with coal. In order to process the coal that fills discharge cone 27, a number of arrangements of plates may be used within the discharge cone. These will be discussed in detail later.

Discharge cone 27 includes valve 27a and is connected via discharge chute 28 to a cooling drum 29. In use, after the coal has been treated, it passes through the discharge chute 28 into cooling drum 29 where the hot coal is cooled to a temperature of less than about 70° C. The cooling drum maybe fitted with plate coolers that are essentially similar to the plates shown in FIG. 1, with cooling water flowing through the channels in the plates. After cooling to the desired temperature, the processed coal is discharged through bottom outlet 30 via valve 30a. The cooling plates may be used to raise steam and to recover heat.

Operation of the apparatus shown in FIG. 2 will now be described. After filling the reactor 20 with coal, the reactor is sealed and pressurised and hot heat transfer oil supplied to the channels in the plates 12a, 12b-12h. The hot oil is typically at a temperature of 350 to 380° C. (662-716° F.). It will be appreciated that different coal types and other solids being processed may require different optimum temperatures from those quoted above. The hot oil may be supplied to the plates before the reactor is filled with coal, during filling or after the reactor has been filled with coal. Due to the high thermal conductivity of the plates 12a, 12b etc. the plates rapidly heat to substantially the temperature of the oil (in subsequent cycles, the plates will already be hot). Heat is then transferred from the hot plates into the coal. This causes the temperature of the coal to increase and a swelling or squeeze reaction begins to occur as structural realignment of the coal forces water out of the coal. After maintaining the coal in the reactor for the desired period of time, the reactor is vented to let down the pressure from the reactor and the processed coal is discharged into the cooling drum 29, where it is cooled and subsequently discharged for sale or further processing, eg. into briquettes.

FIGS. 3 and 4 show side elevations of the discharge cone 27 and bottom portion of reactor 20 of FIG. 2, with possible arrangements of plates 12a-12h (shown in dotted outline) in the cone to ensure that any coal in the cone is sufficiently heated to elevated temperature for sufficient time to be fully processed.

As shown in FIG. 3, the plates 12a-12h extend downwardly into the cone to differing extents, with the central plates extending further into the cone. The arrangement of FIG. 3 ensures that coal can freely flow through the cone whilst ensuring adequate heat transfer into the coal in the cone.

In FIG. 4, the plates 12a-12h are shaped to follow the contours of the cone. Again, some of the plates extend further into the cone than others in order to ensure that coal can freely flow through the cone.

FIG. 5 shows a plan view of the cone 27. In FIG. 5, a series of radial plates 32a to 32h are fitted permanently into the cone 27. Plates 32a to 32h may be provided with their own oil supply or they may be fed from oil line 24 shown in FIG. 2.

The plates shown in FIG. 1 have a cross section that tapers inwardly from the heating oil channels. However, other plate cross sections may be used and some alternative cross sections are shown in FIG. 6.

FIG. 6a shows a plate having a broad central section 34 with the oil channel 35 formed in the central section and tapering to narrow ends 36, 37.

FIG. 6b shows a plate having a generally parallelpied cross section. The plate shown in Figure b is a relatively small plate.

FIG. 6c shows a plate 38 having a square oil channel 39 formed in a central part thereof and tapering to points 40 and 41.

FIG. 6d shows a plate configuration generally similar to that shown in FIG. 1, with the exception that the oil channels 42, 43 are of circular cross section.

FIG. 6e shows a plate that is generally similar to that shown in FIG. 6d but with the oil channels 44, 45 including inwardly shaped projections from the plate to increase the area of heat transfer from the channel into the plate. This is more clearly shown in FIG. 6f which shows a much broader plate than shown in FIG. 6e and this plate has correspondingly larger oil channels 46, 47.

FIG. 6g shows a rectangular plate having circular cross section oil channels.

The reactor design and plate configurations shown in FIGS. 1 to 6 may be subject to a number of variations. In particular, the spacing of the plates 12a-12h may be varied in accordance with the conductivity of the material of construction for the plates, the flowability of the solids material fed to the reactor and the residence time requirements for the reaction. The thickness of the plates may also vary. It has been shown that as the thickness of the plates increases, the “thermal capacitance” of the plates increases and this acts to damp out any temperature drops that may occur during the course of particular reactions. In this regard, it is believed that thicker plates have greater thermal mass or thermal ballast and can act to buffer the enthalpy requirements of the process. The plates 12a-12h may be arranged so that they extend substantially vertically in the reactor (as shown in FIGS. 1 and 2). However, the plates may also be positioned in a horizontal or inclined orientation. The plates are preferably arranged in a vertical orientation as gravity can be used to assist in discharge of the solids from the reactor. It may also be possible to include one or more transverse extensions extending from the surface of the plates in order to improve the heat transfer into the solids material. Any such transverse extensions should be arranged so that impediment to solid flow is minimised.

The plates 12a-12h are preferably mounted loosely in the reactor and preferably are connected at one end only to the reactor. For example, the plates could be suspended on chains. Spacers may be required between the plates and the spacers preferably allow for some movement of the plates. This arrangement allows for movement of the plates if one of the flow channels between the plates becomes blocked, which movement would assist in clearing the blockage. It may also be possible to include means to move the plates, such as pushrods, hammers or vibrators.

The plates may be removable from the reactor, either singularly or as a whole assembly, in order to allow for maintenance of the plates or replacement of plates.

The plates could also include venting channels or injection channels to allow for selective venting of the solids material or selective injection of other agents into the bed of solids material.

As the pressure vessel comprising the outer shell of the reactor is now completely independent of the heating devices (apart from oil pipes in and out), the vessel can be lined with an insulating material (such as a refractory lining) and also possibly a wear liner. This makes it possible for the operating temperature of the structural wall and flanges of the reactor to be kept below 100° C., which can result in considerable savings in steel used. The outer shell of the reactor requires full pressure rating, but as it can run “cold” it may be designed without derating the allowable metal stress for temperature.

FIG. 7 shows a time-temperature profile for points in a rectangular plate subjected to heat flux associated with the Koppelman process for upgrading coal. This process is a batch process and as can be seen from the plot of heat flux the enthalpy requirements of the process vary greatly with time. The temperature-time profile plotted at the top of FIG. 7 shows that the temperature across the plates does change during the process but the maximum temperature drop of approximately 40° C. at time t=20 minutes still enables satisfactory processing of the coal to be achieved. The temperature across the plates substantially recovers to the initial value 70 minutes. It will be appreciated by those skilled in the art that the cycle time, plate mass, plate spacing and materials can be optimised.

The reactor of the present invention has the following advantages over prior art reactors:

Increased volume occupancy by the solids material to be processed in the reactor, typically greater than 60% which either increases the output from a given reactor or allows the use of a smaller reactor for a required output.

The pressure vessel can run cold due to the ability to put an insulating lining into the vessel.

The volume of heating oil is lowered.

Optimised oil heat transfer.

Substantially rectangular, semi-constrained solids bed located between adjacent plates, allowing better solids flow.

Heating for discharge cone.

Levelling of oil heat transfer rate over reaction cycle.

Avoids need for expansion joints in the main vessel.

Avoid differential expansion problems in the shell and tube heat exchange.

Retrofittable to existing shell and tube reactors.

Removable for maintenance or modification.

Ease of purging of heat transfer fluid and option to switch fluids.

Allows further scale up beyond that achievable with plate and tube.

Those skilled in the art will appreciate that the invention described herein is susceptible to modifications and variations other than those specifically described. It is to be understood that the invention encompasses all such variations and modifications that fall within its spirit and scope.

1. A reactor for use in a process in which a charge of material containing solids is supplied to the reactor and forms a packed bed of solids in the reactor and is subjected to heat transfer to heat or cool the charge, the charge having a low thermal conductivity, which reactor includes an outer shell that defines an internal volume for the packed bed and a plurality of plates of a thermally conductive material positioned within the internal volume, and each plate includes one or more passageways through which a heat transfer fluid can flow, and each plate in use defines one or more thermally conductive bypass between the heat transfer fluid and the solids in the region of the plate such that in use substantially all of the solids are heated or cooled to a desired temperature range by heat exchange between the heat transfer fluid and the solids via the plates.

2. The reactor defined in claim 1 wherein the outer shell is rated as a pressure vessel.

3. The reactor defined in claim 1 or claim 2 wherein the plates are positioned relative to each other such that in use solids can flow between adjacent plates during loading and unloading of the reactor.

4. The reactor defined in claim 3 wherein the plates are positioned relative to each other such that the spacing between adjacent plates is sufficiently large to ensure that undue blocking or bridging between the plates by solids does not occur.

5. The reactor defined in claim 4 wherein the spacing between adjacent plates is from 50-500 mm.

6. The reactor defined in claim 5 wherein the spacing between adjacent plates is from 75-200 mm.

7. The reactor defined in any one of the preceding claims wherein the thermal conductivity of the plates is at least an order of magnitude higher than the thermal conductivity of the charge in the reactor during operation.

8. The reactor defined in any one of the preceding claims wherein each plate includes one passageway only or a small number of the passageways.

9. The reactor defined in any one of the preceding claims wherein each passageway has a relatively small diameter or width.

10. The reactor defined in any one of the preceding claims wherein the total volume of the passageway or passageways in each plate is a small percentage of the total volume of the plate.

11. The reactor defined in any one of the preceding claims wherein the plates have a rectangular, parallelogram, or tapering cross section.

12. The reactor defined in any one of the preceding claims wherein the outer shell includes a substantially cylindrical portion with the plates arranged such that, when viewed in cross section, the plates substantially extend across chords of the cross section of the cylindrical portion.

13. The reactor defined in claim 12 wherein the plates extend substantially along the length of the cylindrical portion.

14. The reactor defined in claim 12 or claim 13 wherein the longitudinal axis of the cylindrical portion is substantially vertical.

15. The reactor defined in any one of claims 12 to 14 wherein the outer shell further includes a conical discharge portion extending from an end of the cylindrical portion.

16. The reactor defined in claim 15 wherein the discharge portion has an internal volume that is up to 20% of the total internal volume of the outer shell.

17. The reactor defined in claim 15 or claim 16 wherein said plates extend into the discharge portion.

18. A process for heating or cooling solids having low thermal conductivity in a reactor having an outer shell and a plurality of plates of thermally conductive material positioned within the outer shell, each of said plates having one or more passageways for flow of a heat transfer fluid therethrough, and each of said plates defining in use one or more thermally conductive bypass between the heat transfer fluid and solids in the region of the plate, which method includes the steps of charging the solids into the reactor to form a packed bed in the outer shell, passing a heat transfer fluid through said passageways and heating or cooling solids in the packed bed by heat transfer between the heat transfer fluid and solids via the plates, and removing solids from the reactor.

19. The process defined in claim 18 includes the step of pressurising the packed bed of solids.

20. The process defined in claim 18 or claim 19 when operated for heating solids includes maintaining the packed bed under conditions of elevated temperature and elevated pressure for a time sufficient to upgrade the solids.

21. The process defined in claim 19 includes maintaining the solids at elevated temperature and elevated pressure for a period of 15 minutes to one hour.

22. The process defined in claim 20 or claim 21 includes pressurising the packed bed to a pressure of at least 4 barg.

23. The process defined in any one of claims 18 to 22 wherein the solids are coarse.

24. The process defined in any one of claims 18 to 23 includes operating the process on a batch basis.

25. The process defined in any one of claims 18 to 24 wherein the solids include coal.
